(19) United States
(12) Patent Application Publication
(10) Pub. No.: US 2012/0254589 A1
(43) Pub. Date: Oct. 4, 2012

(54) SYSTEM, APPARATUS, AND METHOD FOR ALIGNING REGISTERS

(76) Inventors: Jesus Corbal San Adrian, Barcelona (ES); Roger Espasa Sans, Mallorca (ES); Milind Baburao Girkar, Sunnyvale, CA (US); Lisa K. Wu, New York, NY (US); Dennis R. Bradford, Portland, OR (US); Victor W. Lee, Santa Clara, CA (US)

(21) Appl. No.: 13/078,868

(22) Filed: Apr. 1, 2011

(51) Int. Cl. G06F 9/30; G06F 9/315

(52) U.S. Cl. 712/204; 712/E09.023; 712/E09.034

(57) ABSTRACT

Embodiments of systems, apparatuses, and methods for performing an align instruction in a computer processor are described. In some embodiments, the execution of an align instruction causes the selective storage of data elements of two concatenated sources to be stored in a destination.

### FIELD OF INVENTION

The field of invention relates generally to computer processor architecture, and, more specifically, to instructions which when executed cause a particular result.

### BACKGROUND

As the Single Instruction, Multiple Data (SIMD) width of processors increases, it is increasingly difficult for application developers (and compilers) to fully utilize SIMD hardware since data elements are not naturally aligned to the size of a full vector and usually produce cache line splits where a memory reference is located in two distinctive lines of the cache memory hierarchy. Traditionally, dealing with cache line splits involves: detecting the cache-line split condition, performing two different TLB look-ups, performing two cache-line accesses, and thereby using two independent memory ports, and/or using dedicated logic to merge the pieces of data coming from the two consecutive cache lines on the way from memory.

### BRIEF DESCRIPTION OF THE DRAWINGS

The present invention is illustrated by way of example and not limitation in the figures of the accompanying drawings, in which like references indicate similar elements and in which:

FIG. 1 depicts an exemplary execution of an ALIGN instruction.

FIG. 2 depicts an exemplary execution of an ALIGN instruction.

FIG. 3 depicts an exemplary execution of an ALIGN instruction.

FIG. 4 illustrates an embodiment of a method for aligning data from two sources and storing that alignment into a destination location by executing an align instruction in a processor.

FIG. 5 illustrates an embodiment of a method for processing an align instruction.

FIG. 6 illustrates an embodiment of a method for processing an align instruction.

FIG. 7 illustrates an embodiment of a method for processing an align instruction in pseudo-code.

FIG. 8A is a block diagram illustrating a generic vector friendly instruction format and class A instruction templates thereof according to embodiments of the invention.

FIG. 8B is a block diagram illustrating the generic vector friendly instruction format and class B instruction templates thereof according to embodiments of the invention.

FIG. 9 is a block diagram illustrating an exemplary specific vector friendly instruction format according to embodiments of the invention.

FIG. 10 is a block diagram of a register architecture according to one embodiment of the invention.

FIG. 11A is a block diagram of a single CPU core, along with its connection to the on-die interconnect network and with its local subset of the level 2 (L2) cache, according to embodiments of the invention.

FIG. 11B is an exploded view of part of the CPU core in FIG. 11A according to embodiments of the invention.

FIG. 12 is a block diagram illustrating an exemplary out-of-order architecture according to embodiments of the invention.

FIG. 13 is a block diagram of a system in accordance with one embodiment of the invention.

FIG. 14 is a block diagram of a second system in accordance with an embodiment of the invention.

FIG. 15 is a block diagram of a third system in accordance with an embodiment of the invention.

FIG. 16 is a block diagram of a SoC in accordance with an embodiment of the invention.

FIG. 17 is a block diagram of a single core processor and a multicore processor with integrated memory controller and graphics according to embodiments of the invention.

FIG. 18 is a block diagram contrasting the use of a software instruction converter to convert binary instructions in a source instruction set to binary instructions in a target instruction set according to embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As detailed earlier, the traditional alignment of data elements required several processes resulting in some undesirable consequences. For example, in some situations, users specify potential misalignment behavior via specific mnemonics (such as executing instructions like VMOVUPS) causing slower execution due to the assumption that cache-line splits are always going to be produced. In other situations, the hardware is left to detect cache misalignment at runtime resulting in an extra performance penalty.

Align

Embodiments of vector align (VALIGN) instruction are detailed below and embodiments of systems, architectures, instruction formats etc. that may be used to execute such instructions. When executed, a vector align instruction causes a processor to concatenate data elements of a first and second source operand of the instruction, shift right data elements from that concatenated data based on an offset (immediate) value of the instruction, and store one or more of the elements of the shifted concatenated data into a destination vector register. In some embodiments, the element(s) of the shifted concatenated data to be stored in the destination vector register are determined by corresponding bits of a writemask register. The first and second sources may both be registers, memory locations, or a combination thereof. In some embodiments, when the source is a memory location its data is loaded into a register prior to the concatenation.

An example of this instruction is “VALIGND zmm1 {k1}, zmm2, zmm3/m512, offset,” where zmm1, zmm2, zmm3 are vector registers (such as 128-, 256-, 512-bit registers), m512 is a 512-bit memory operand stored either in a register or an immediate, k1 is a writemask operand (such as a 16-bit register like those detailed earlier), and the offset is an immediate (for example, 8-bit immediate) that dictates the alignment in 32-bit elements of the data elements of the sources after they have been concatenated as will be detailed below. Whatever is retrieved from memory is a collection consecutive bits starting from the memory address and may one of several sizes (128-, 256-, 512-bit, etc.) depending on the size of the destination register—the size is generally the same size as the destination register. In some embodiments, the writemask is also of a different size (8 bits, 32 bits, etc.). Additionally, in some embodiments, not all bits of the writemask are utilized by the instruction (for example, only the least significant eight bits are used). Of course, VALIGND is the instruction's opcode. Typically, each operand is explicitly defined in the instruction. The size of the data elements may be defined in the “prefix” of the instruction such as through the use of an indication of data granularity bit like “W” described earlier. In most embodiments, W will indicate that each data elements are either 32 or 64 bits. If the data elements are 32 bits in size, and the sources are 512 bits in size, then there are sixteen (16) data elements per source.

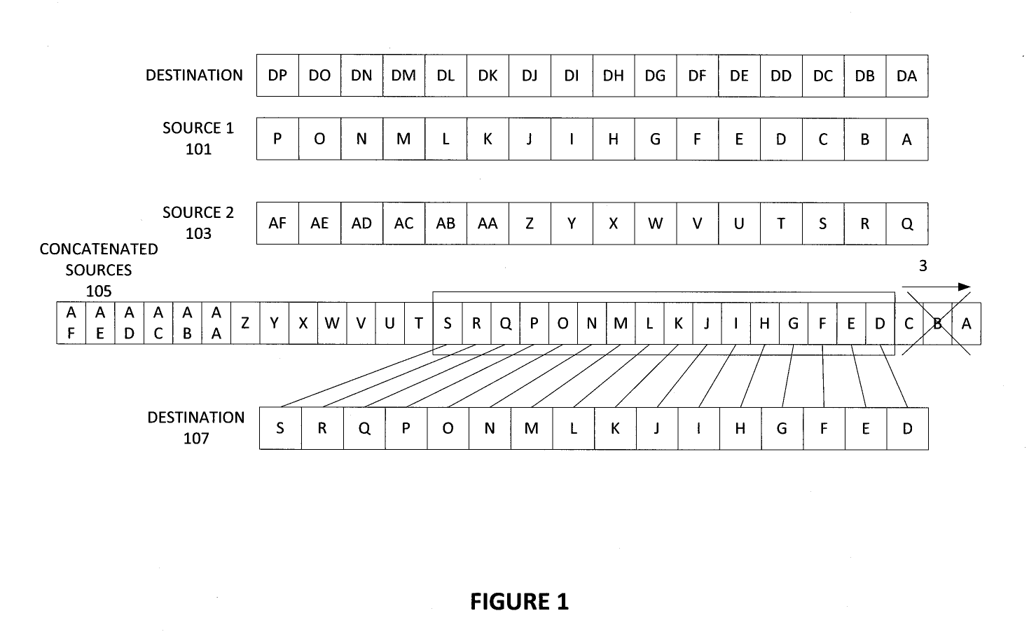

FIG. 1 depicts an exemplary execution of an ALIGN instruction. In this example, there are two sources each having 16 data elements. In most cases, one of these sources is a register (for this example, source 1 101 is treated as being a 512-bit register such as a ZMM register with 16 32-bit data elements, however, other data element and register sizes may be used such as XMM and YMM registers and 16- or 64-bit data elements). The other source 103 is either a register or a memory location (in this illustration source 2 is the other source). If the second source is a memory location, in most embodiments it is placed into a temporary register prior to any blending of the sources. Additionally, data elements of the memory location may undergo a data transformation prior to that placement into the temporary register. Data 103 includes sixteen data elements from A through P and data 103 includes sixteen data elements from Q through AF.

As illustrated, the data from the registers 101 and 103 is concatenated 105 with the least significant data element of the first data register 101, A, being the least significant data element of the concatenated data 105. The least significant data element of the second data register 103, Q, immediately follows the most significant data element of the first data register 101. The concatenated data elements 105 are shifted (aligned) by three (the immediate value of the instruction) which leaves data elements D through AF from the original sources. Of course, big-endian style could also be used and the data elements would be shifted left by the corresponding immediate value.

The least significant data elements (D through S) of this shifted and concatenated data are written into the destination register of the instruction until there are no more data element slots in the destination register. In other embodiments the most significant data elements are written into the destination register 107. This writing may be done in parallel or serially. As illustrated, the sixteen least significant data elements are written into the destination register as it only has room to store sixteen data elements of this size.

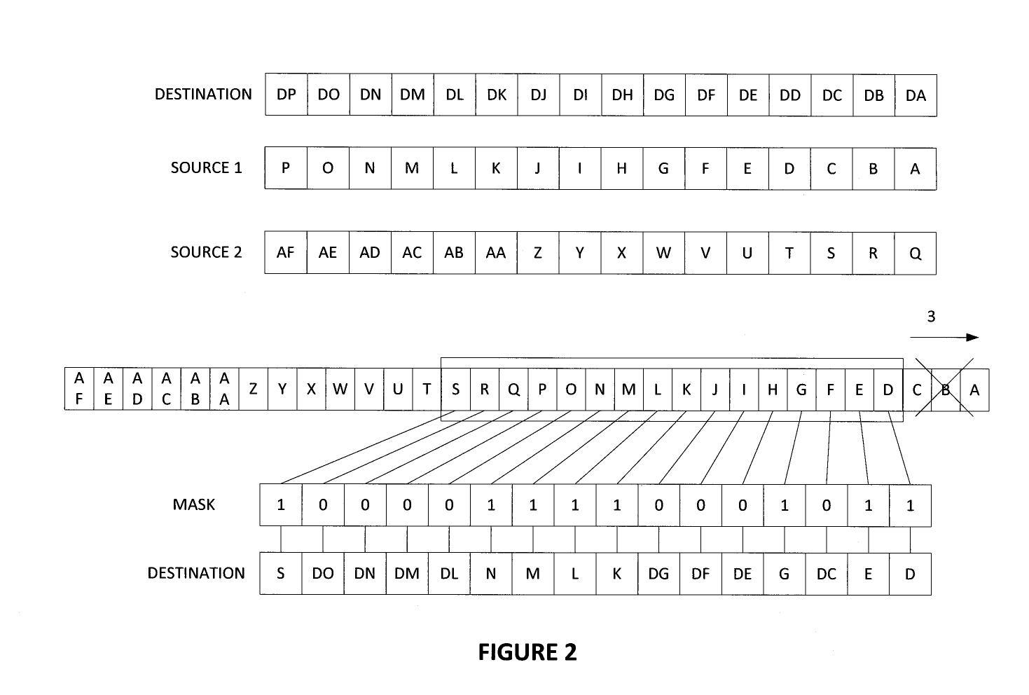

FIG. 2 illustrates the same source data and shift, but uses the contents of a mask register 201 to determine which of the least significant data elements of the concatenated and shifted data 105 should be written into the destination register. In some embodiments, this mask register is a “k” mask register (k1-k7) detailed above. The mask register is shown as 0x878B. For each position of the mask that stores a value of “1,” the corresponding data element from the concatenated and shifted data 105 is written into the corresponding position of the destination register. For example, since position “0” of the mask is a “1,” then the value, D, of the corresponding data element position “0” of the shifted and concatenated data elements is stored into the “0” position of the destination register. For each position of the mask that stores a value of “0,” the corresponding data element of the destination register is not overwritten. For example, in position “2” the mask is a “0” so the destination remains DC instead of being overwritten with a value of F. While “1” is shown as being an indication that a particular data element position should be written into the destination register and a “0” indicates not to do that writing, in other embodiments the opposite convention is used. Additionally, in some embodiments the most significant data elements are written and not the least significant.

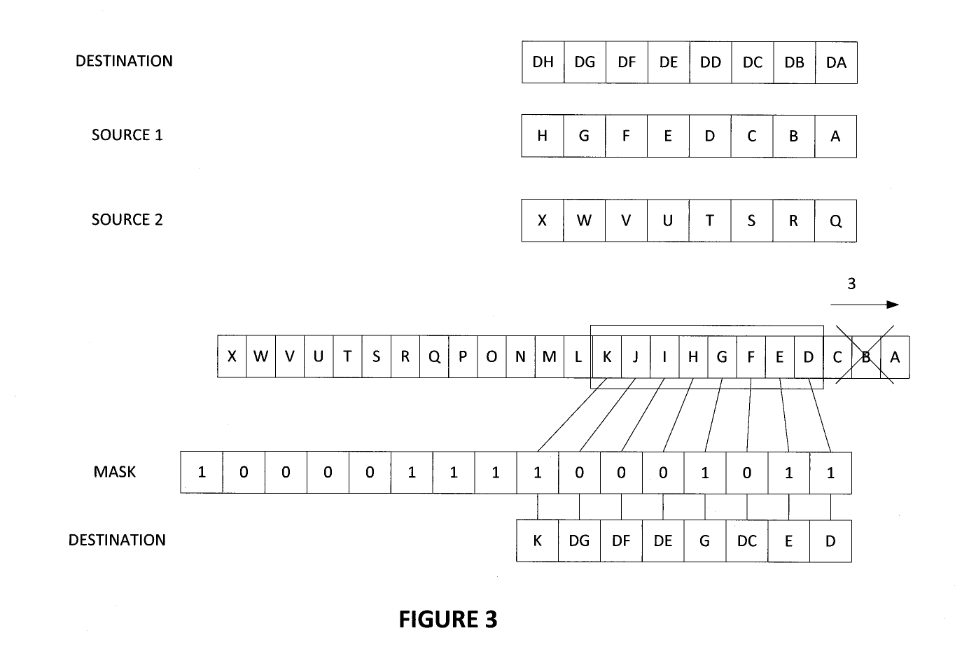

FIG. 3 illustrates the same source data and shift, but uses the contents of a mask register to determine which of the least significant data elements of the concatenated and shifted data 105 should be written into the destination register. In this instance, not all of the mask bits are used. This may happen, for example, in some embodiments with 64-bit data elements and 512-bit registers.

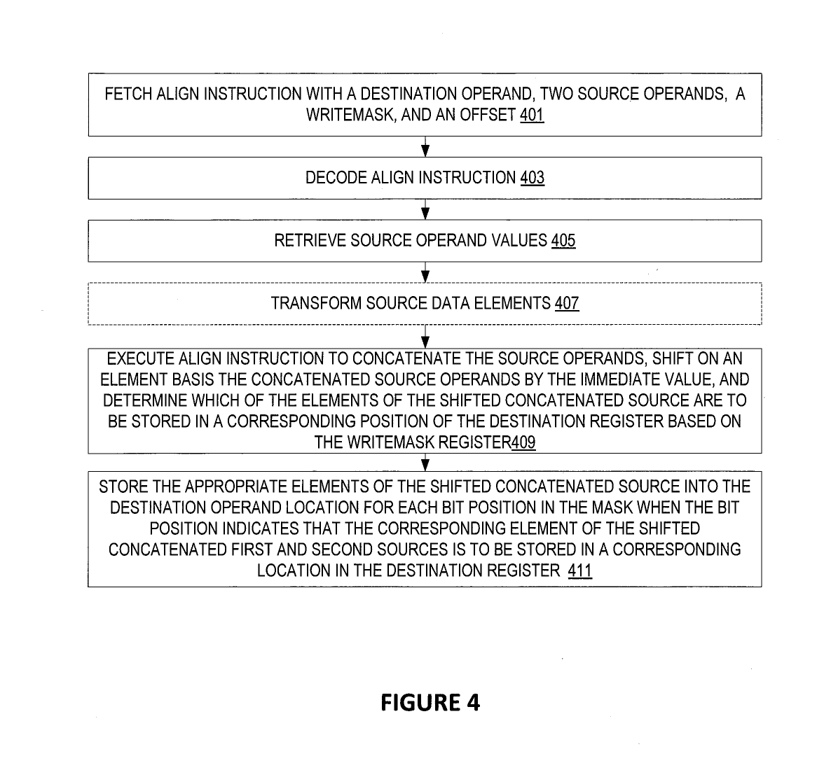

FIG. 4 illustrates an embodiment of a method for aligning data from two sources and storing that alignment into a destination location by executing an align instruction in a processor. At 401, an align instruction with a destination operand, first and second source operands, an offset (immediate) value, and a mask operand is received. The destination and source operands are of the same size. In some embodiments, they are all 512 bits in size. However, in other embodiments they may all be different sizes such as 128 or 256 bits. Typically, the destination and first source operand are both registers such as one of the vector registers (XMM, YMM, or ZMM) described above. The second source operand may either be a register or a memory operand. In some embodiments, the offset is an 8-bit immediate. The mask that is received may be one of the “k” writemasks described earlier or in some embodiments it is a different register or memory location.

The align instruction is decoded at 403. Depending on the instruction's format, a variety of data may be interpreted at this stage such as if there is to be a data transformation, which registers to write to and retrieve, what memory address to access using the memory source operand and potentially the offset if included, etc.

The source operand values are retrieved/read at 405. If both sources are registers then those registers are read. If one or both of the source operands is a memory operand, then the data elements associated with that operand are retrieved. In some embodiments, data elements from memory are stored into a temporary register.

If there is any data element transformation to be performed (such as an upconversion, broadcast, swizzle, etc.) it may be performed at 407. For example, a 16-bit data element from memory may be upconverted into a 32-bit data element or data elements may be swizzled from one pattern to another (e.g., XYZW XYZW XYZW . . . XYZW to XXXXXXXX YYYYYYYY ZZZZZZZZZZ WWWWWWWW).

The align instruction is executed at 409. The execution of this instruction causes the concatenation of the data elements of the first and second source operands, shifting right of these data elements from that concatenated data based on the offset. In some embodiments, the first source operands data elements are the least significant of the concatenated data elements. Some of the data elements of the shifted concatenated data may be stored into a destination vector register at 411 depending the corresponding bits of the writemask register. While 409 and 411 have been illustrated separately, in some embodiments they are performed together as a part of the execution of the instruction.

While the above has been illustrated in one type of execution environment it is easily modified to fit in other environments such as the in-order and out-of-order environments detailed.

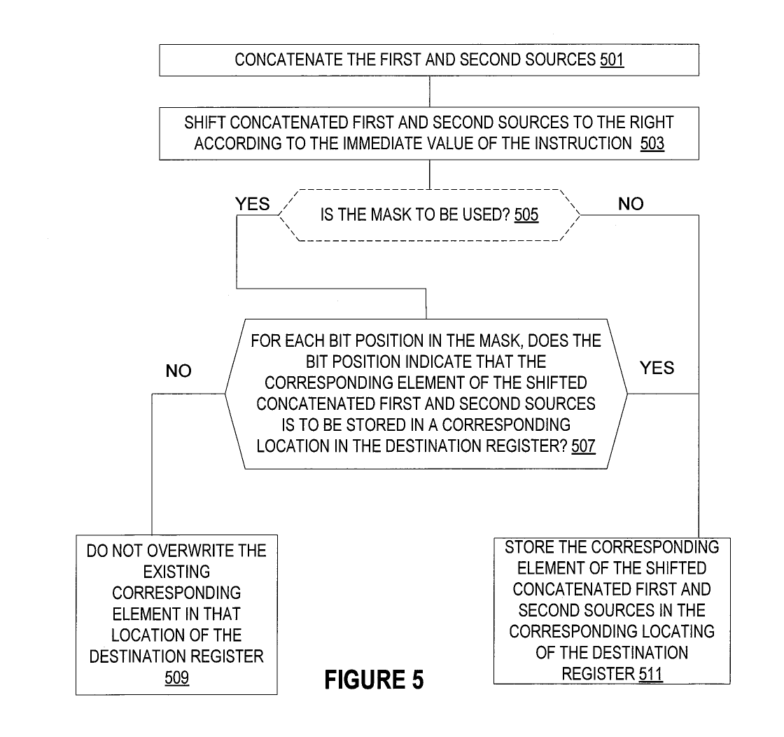

FIG. 5 illustrates an embodiment of a method for processing an align instruction. In this embodiment it is assumed that some, if not all, of the operations 401-407 have been performed earlier, however, they are not shown in order to not obscure the details presented below. For example, the fetching and decoding are not shown, nor is the operand (sources and writemask) retrieval shown.

The data elements of the first and second sources are concatenated at 501 to create a larger “vector” to operate on. For example, the data from two source registers is concatenated such that the data elements of the first source are the lower significant bits and the data elements of the second source are the most significant as illustrated in FIGS. 1 and 2. In some embodiments, this larger vector is 1024 bits. Clearly, this size of the larger vector is dependent upon the size of the sources.

The concatenated data of the first and second sources is shifted to the right by an amount of data elements defined by the immediate value of the instruction at 503.

A determination of if a writemask is to be used may be made at 505. This is optional depending on the implementation of the underlying hardware architecture. For example, if a writemask register like k0 detailed above is used there will be no mask used. While k0 is a register that may be written to when it is included in an instruction it means that no masking is to be performed (in other words it is essentially at “1” value at all bit positions). Of course, in other architectures it could be used as any other register would be.

If the writemask is to be used, then for each bit position in the writemask, a determination of if that bit position indicates that the corresponding element of the shifted concatenated data of the first and second sources is to be stored in a corresponding location of the destination register is made at 507. In some embodiments, this determination, and/or potentially later storage at 511, is performed serially—that is, for the determination is made for the first bit position (i.e., k1[0]) and then the sequential bit position is evaluated. In other embodiments, this determination, and/or potentially later storage at 511, is performed in parallel—that is, for the determination is made for all of the bit position (i.e., k1[0]-k1[15]) at the same time. Additionally, the number of bit positions to be evaluated varies depending on the data element size. For example, in a 512-bit implementation with 32-bit data elements, sixteen (16) bits of the mask are evaluated for this determination. In a 512-bit implementation with 64-bit data elements only eight (8) bits of the mask are evaluated. In this instance, typically the least significant eight (8) bits are evaluated, but other conventions could be used.

When a bit position of the mask indicates that nothing should be written into the corresponding data element position of the destination register, then nothing is written into the destination register at 509. When a bit position of the mask indicates that the corresponding data of the shifted concatenated data should be written into the corresponding data element position of the destination register, then it is written into the corresponding data element position of the destination register at 511. An example of such storage is shown in FIG. 2. If a mask is not to be used, then all of the corresponding data elements of the shifted concatenated data are stored in the corresponding data element positions of the destination register at 511. An example of such storage is shown in FIG. 1.

Once the final bit position of the mask to be looked at as been evaluated, or all data element positions in the destination that could be written to have been, the method ends.

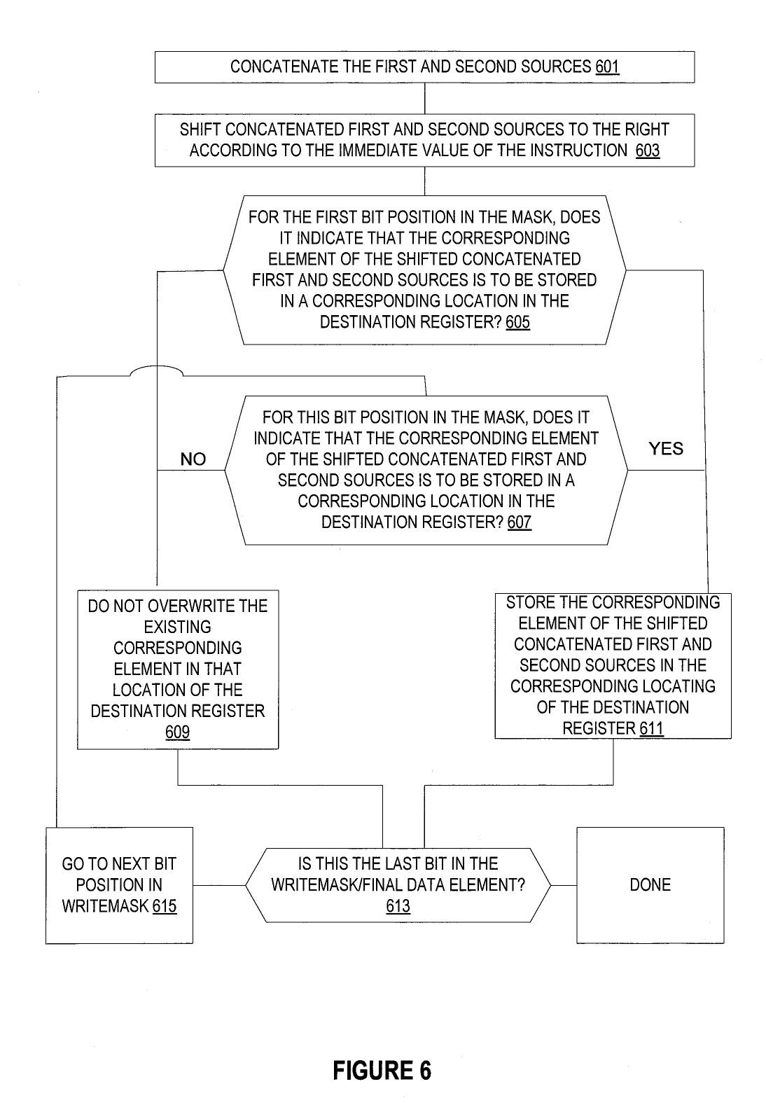

FIG. 6 illustrates an embodiment of a method for processing an align instruction. In this embodiment it is assumed that some, if not all, of the operations 401-407 have been performed earlier, however, they are not shown in order to not obscure the details presented below. For example, the fetching and decoding are not shown, nor is the operand (sources and writemask) retrieval shown.

The data elements of the first and second sources are concatenated at 601 to create a larger “vector” to operate on. For example, the data from two source registers is concatenated such that the data elements of the first source are the lower significant bits and the data elements of the second source are the most significant as illustrated in FIGS. 1 and 2. In some embodiments, this larger vector is 1024 bits. Clearly, this size of the larger vector is dependent upon the size of the sources.

The concatenated data of the first and second sources is shifted to the right by an amount of data elements defined by the immediate value of the instruction at 603.

A determination of if a writemask is to be used may also be made (not illustrated). This is optional depending on the implementation of the underlying hardware architecture as detailed earlier. If a mask is not to be used, then no check would be made at 605 or 607.

For the first bit position in the writemask, a determination of if that bit position indicates that the corresponding element of the shifted concatenated data of the first and second sources is to be stored in a corresponding location of the destination register is made at 605. If the first bit position of the mask indicates that nothing should be written into the corresponding data element position of the destination register, then nothing is written into the destination register at 609. If the first bit position of the mask indicates that the corresponding data of the shifted concatenated data should be written into the corresponding data element position of the destination register, then it is written into the corresponding data element position of the destination register at 611. An example of such storage is shown in FIG. 2.

A determination of if the evaluated writemask position was the last of the writemask or if all of the data element positions of the destination have been filled is made at 613. If true, then the operation is over. The latter case may occur when, for example, the data element sizes are 64 bits, the destination is 512 bits, and the writemask has 16 bits. In that instance, only 8 bits of the writemask would be necessary

If not true, then the next bit position in the writemask is to be evaluated to determine its value at 615. And the bit position is evaluated at 607, etc. Once the final bit position of the mask to be looked at as been evaluated, or all data element positions in the destination that could be written to have been, the method ends.

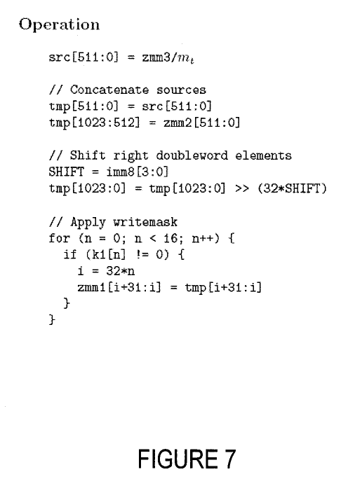

FIG. 7 illustrates an embodiment of a method for processing an align instruction in pseudo-code.

Programs typically access memory in a sequential fashion. For example, reference (a) is accessed at a first 512-bit vector located at address @, reference (b) is accessed at a second 512-bit vector located at address @+64 bytes, and reference (c) is accessed at a first 512-bit vector located at address @+128 bytes. In this scenario, reference (a) is located across cache-lines A and B, reference (b) is located across cache-lines B and C, and reference (c) is located across cache-lines C and D. Using regular loads, cache-lines B and C would be accessed twice and the number of overall cache-line accesses would be 6 (3×2).

In general terms, cache line ports are a more precious resource than register ports. Embodiments of the align instruction discussed above perform data alignment on registers rather than on cache lines and thus such an instruction provides for performance gains. Using the align instruction, cache-line data is aligned in registers and there is typically only one new cache line fetched per vector reference—instead of accessing every cache-line twice, it is only read it once and aligned concurrently with the cache access, leveraging a throughput of one vector every cycle still using just one single memory port.

Embodiments of the instruction(s) detailed above are embodied may be embodied in a “generic vector friendly instruction format” which is detailed below. In other embodiments, such a format is not utilized and another instruction format is used, however, the description below of the writemask registers, various data transformations (swizzle, broadcast, etc.), addressing, etc. is generally applicable to the description of the embodiments of the instruction(s) above. Additionally, exemplary systems, architectures, and pipelines are detailed below. Embodiments of the instruction(s) above may be executed on such systems, architectures, and pipelines, but are not limited to those detailed.

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

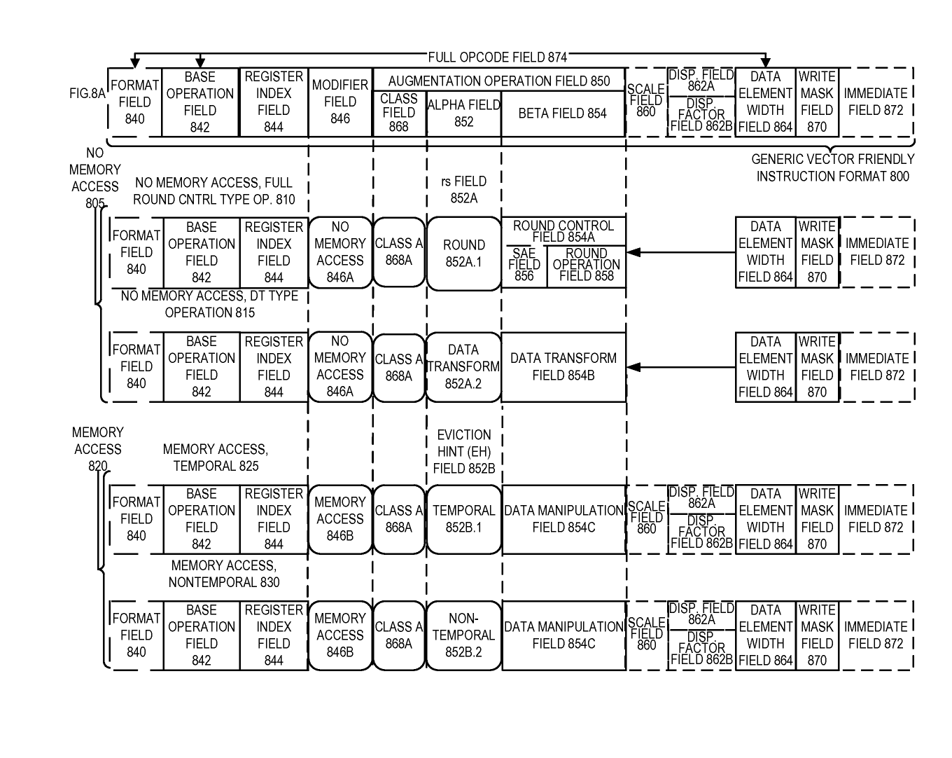

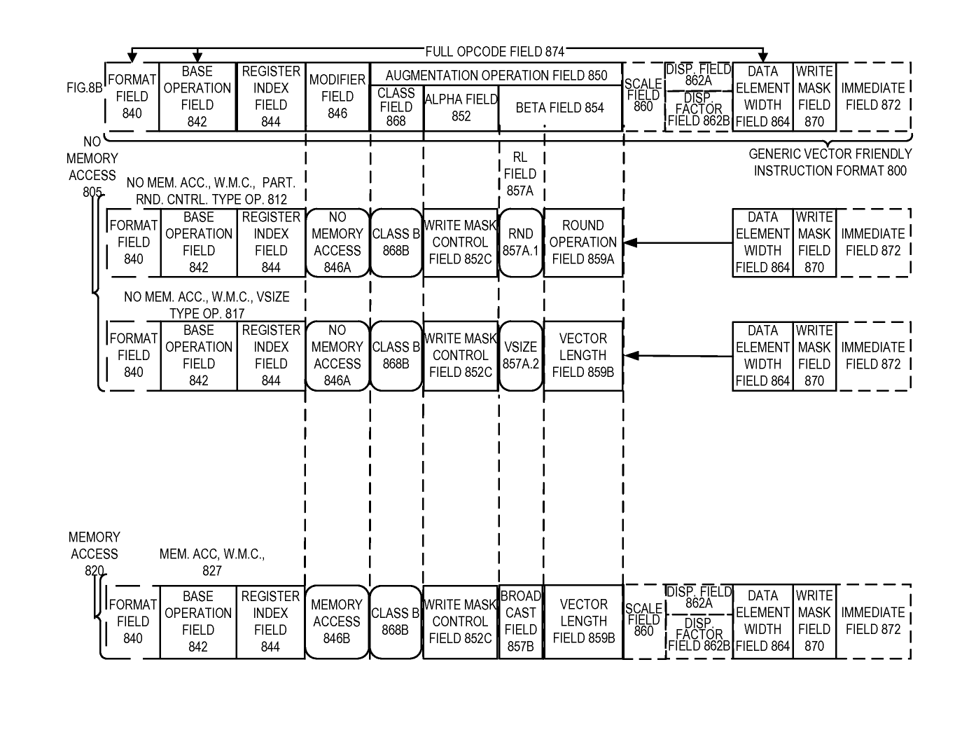

Exemplary Generic Vector Friendly Instruction Format—FIG. 8A-B

FIGS. 8A-B are block diagrams illustrating a generic vector friendly instruction format and instruction templates thereof according to embodiments of the invention. FIG. 8A is a block diagram illustrating a generic vector friendly instruction format and class A instruction templates thereof according to embodiments of the invention; while FIG. 8B is a block diagram illustrating the generic vector friendly instruction format and class B instruction templates thereof according to embodiments of the invention. Specifically, a generic vector friendly instruction format 800 for which are defined class A and class B instruction templates, both of which include no memory access 805 instruction templates and memory access 820 instruction templates. The term generic in the context of the vector friendly instruction format refers to the instruction format not being tied to any specific instruction set. While embodiments will be described in which instructions in the vector friendly instruction format operate on vectors that are sourced from either registers (no memory access 805 instruction templates) or registers/memory (memory access 820 instruction templates), alternative embodiments of the invention may support only one of these. Also, while embodiments of the invention will be described in which there are load and store instructions in the vector instruction format, alternative embodiments instead or additionally have instructions in a different instruction format that move vectors into and out of registers (e.g., from memory into registers, from registers into memory, between registers). Further, while embodiments of the invention will be described that support two classes of instruction templates, alternative embodiments may support only one of these or more than two.

While embodiments of the invention will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 856 byte vector operands) with more, less, or different data element widths (e.g., 128 bit (16 byte) data element widths).

The class A instruction templates in FIG. 8A include: 1) within the no memory access 805 instruction templates there is shown a no memory access, full round control type operation 810 instruction template and a no memory access, data transform type operation 815 instruction template; and 2) within the memory access 820 instruction templates there is shown a memory access, temporal 825 instruction template and a memory access, non-temporal 830 instruction template. The class B instruction templates in FIG. 8B include: 1) within the no memory access 805 instruction templates there is shown a no memory access, write mask control, partial round control type operation 812 instruction template and a no memory access, write mask control, vsize type operation 817 instruction template; and 2) within the memory access 820 instruction templates there is shown a memory access, write mask control 827 instruction template.

Format

The generic vector friendly instruction format 800 includes the following fields listed below in the order illustrated in FIGS. 8A-B.

Format field 840—a specific value (an instruction format identifier value) in this field uniquely identifies the vector friendly instruction format, and thus occurrences of instructions in the vector friendly instruction format in instruction streams. Thus, the content of the format field 840 distinguish occurrences of instructions in the first instruction format from occurrences of instructions in other instruction formats, thereby allowing for the introduction of the vector friendly instruction format into an instruction set that has other instruction formats. As such, this field is optional in the sense that it is not needed for an instruction set that has only the generic vector friendly instruction format.

Base operation field 842—its content distinguishes different base operations. As described later herein, the base operation field 842 may include and/or be part of an opcode field.

Register index field 844—its content, directly or through address generation, specifies the locations of the source and destination operands, be they in registers or in memory. These include a sufficient number of bits to select N registers from a P×Q (e.g. 32×1012) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination). While in one embodiment P=32, alternative embodiments may support more or less registers (e.g., 16). While in one embodiment Q=1012 bits, alternative embodiments may support more or less bits (e.g., 128, 1024).

Modifier field 846—its content distinguishes occurrences of instructions in the generic vector instruction format that specify memory access from those that do not; that is, between no memory access 805 instruction templates and memory access 820 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations.

Augmentation operation field 850—its content distinguishes which one of a variety of different operations to be performed in addition to the base operation. This field is context specific. In one embodiment of the invention, this field is divided into a class field 868, an alpha field 852, and a beta field 854. The augmentation operation field allows common groups of operations to be performed in a single instruction rather than 2, 3 or 4 instructions. Below are some examples of instructions (the nomenclature of which are described in more detail later herein) that use the augmentation field 850 to reduce the number of required instructions.

| | Instructions Sequences according to |
|---|---|
| Prior Instruction Sequences | on Embodiment of the Invention |
| vaddps ymm0, ymm1, | vaddps zmm0, zmm1, zmm2 |
| ymm2 | |
| vpshufd ymm2, ymm2, 0x55 | vaddps zmm0, zmm1, zmm2 {bbbb} |
| vaddps ymm0, ymm1, ymm2 | |
| vpmovsxbd ymm2, [rax] | vaddps zmm0, zmm1, [rax]{sint8} |
| vcvtdq2ps ymm2, ymm2 | |
| vaddps ymm0, ymm1, ymm2 | |
| vpmovsxbd ymm3, [rax] | vaddps zmm1{k5}, zmm2, |
| vcvtdq2ps ymm3, ymm3 | [rax]{sint8} |
| vaddps ymm4, ymm2, ymm3 | |
| vblendvps ymm1, ymm5, | |
| ymm1, ymm4 | |
| vmaskmovps ymm1, ymm7, [rbx] | vmovaps zmm1 {k7}, [rbx] |
| vbroadcastss ymm0, [rax] | vaddps zmm2{k7}{z}, zmm1, |
| vaddps ymm2, ymm0, ymm1 | [rax]{1toN} |
| vblendvps ymm2, ymm2, | |
| ymm1, ymm7 | |

Where [rax] is the base pointer to be used for address generation, and where { } indicates a conversion operation specified by the data manipulation filed (described in more detail later here).

Scale field 860—its content allows for the scaling of the index field's content for memory address generation (e.g., for address generation that uses 2^{scale}*index+base).

Displacement Field 862A—its content is used as part of memory address generation (e.g., for address generation that uses 2^{scale}*index+base+displacement).

Displacement Factor Field 862B (note that the juxtaposition of displacement field 862A directly over displacement factor field 862B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 874 (described later herein) and the data manipulation field 854C as described later herein. The displacement field 862A and the displacement factor field 862B are optional in the sense that they are not used for the no memory access 805 instruction templates and/or different embodiments may implement only one or none of the two.

Data element width field 864—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 870—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 870 allows for partial vector operations, including loads, stores, arithmetic, logical, etc. Also, this masking can be used for fault suppression (i.e., by masking the destination's data element positions to prevent receipt of the result of any operation that may/will cause a fault—e.g., assume that a vector in memory crosses a page boundary and that the first page but not the second page would cause a page fault, the page fault can be ignored if all data element of the vector that lie on the first page are masked by the write mask). Further, write masks allow for “vectorizing loops” that contain certain types of conditional statements. While embodiments of the invention are described in which the write mask field's 870 content selects one of a number of write mask registers that contains the write mask to be used (and thus the write mask field's 870 content indirectly identifies that masking to be performed), alternative embodiments instead or additional allow the mask write field's 870 content to directly specify the masking to be performed. Further, zeroing allows for performance improvements when: 1) register renaming is used on instructions whose destination operand is not also a source (also call non-ternary instructions) because during the register renaming pipeline stage the destination is no longer an implicit source (no data elements from the current destination register need be copied to the renamed destination register or somehow carried along with the operation because any data element that is not the result of operation (any masked data element) will be zeroed); and 2) during the write back stage because zeros are being written.

Immediate field 872—its content allows for the specification of an immediate. This field is optional in the sense that is it not present in an implementation of the generic vector friendly format that does not support immediate and it is not present in instructions that do not use an immediate.

Instruction Template Class Selection

Class field 868—its content distinguishes between different classes of instructions. With reference to FIGS. 2A-B, the contents of this field select between class A and class B instructions. In FIGS. 8A-B, rounded corner squares are used to indicate a specific value is present in a field (e.g., class A 868A and class B 868B for the class field 868 respectively in FIGS. 8A-B).

No-Memory Access Instruction Templates of Class A

In the case of the non-memory access 805 instruction templates of class A, the alpha field 852 is interpreted as an RS field 852A, whose content distinguishes which one of the different augmentation operation types are to be performed (e.g., round 852A.1 and data transform 852A.2 are respectively specified for the no memory access, round type operation 810 and the no memory access, data transform type operation 815 instruction templates), while the beta field 854 distinguishes which of the operations of the specified type is to be performed. In FIG. 8, rounded corner blocks are used to indicate a specific value is present (e.g., no memory access 846A in the modifier field 846; round 852A.1 and data transform 852A.2 for alpha field 852/rs field 852A). In the no memory access 805 instruction templates, the scale field 860, the displacement field 862A, and the displacement scale filed 862B are not present.

No-Memory Access Instruction Templates—Full Round Control Type Operation

In the no memory access full round control type operation 810 instruction template, the beta field 854 is interpreted as a round control field 854A, whose content(s) provide static rounding. While in the described embodiments of the invention the round control field 854A includes a suppress all floating point exceptions (SAE) field 856 and a round operation control field 858, alternative embodiments may support may encode both these concepts into the same field or only have one or the other of these concepts/fields (e.g., may have only the round operation control field 858).

SAE field 856—its content distinguishes whether or not to disable the exception event reporting; when the SAE field's 856 content indicates suppression is enabled, a given instruction does not report any kind of floating-point exception flag and does not raise any floating point exception handler.

Round operation control field 858—its content distinguishes which one of a group of rounding operations to perform (e.g., Round-up, Round-down, Round-towards-zero and Round-to-nearest). Thus, the round operation control field 858 allows for the changing of the rounding mode on a per instruction basis, and thus is particularly useful when this is required. In one embodiment of the invention where a processor includes a control register for specifying rounding modes, the round operation control field's 850 content overrides that register value (Being able to choose the rounding mode without having to perform a save-modify-restore on such a control register is advantageous).

No Memory Access Instruction Templates—Data Transform Type Operation

In the no memory access data transform type operation 815 instruction template, the beta field 854 is interpreted as a data transform field 854B, whose content distinguishes which one of a number of data transforms is to be performed (e.g., no data transform, swizzle, broadcast).

Memory Access Instruction Templates of Class A

In the case of a memory access 820 instruction template of class A, the alpha field 852 is interpreted as an eviction hint field 852B, whose content distinguishes which one of the eviction hints is to be used (in FIG. 8A, temporal 852B.1 and non-temporal 852B.2 are respectively specified for the memory access, temporal 825 instruction template and the memory access, non-temporal 830 instruction template), while the beta field 854 is interpreted as a data manipulation field 854C, whose content distinguishes which one of a number of data manipulation operations (also known as primitives) is to be performed (e.g., no manipulation; broadcast; up conversion of a source; and down conversion of a destination). The memory access 820 instruction templates include the scale field 860, and optionally the displacement field 862A or the displacement scale field 862B.

Vector Memory Instructions perform vector loads from and vector stores to memory, with conversion support. As with regular vector instructions, vector memory instructions transfer data from/to memory in a data element-wise fashion, with the elements that are actually transferred dictated by the contents of the vector mask that is selected as the write mask. In FIG. 8A, rounded corner squares are used to indicate a specific value is present in a field (e.g., memory access 846B for the modifier field 846; temporal 852B.1 and non-temporal 852B.2 for the alpha field 852/eviction hint field 852B)

Memory Access Instruction Templates—Temporal

Temporal data is data likely to be reused soon enough to benefit from caching. This is, however, a hint, and different processors may implement it in different ways, including ignoring the hint entirely.

Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

Instruction Templates of Class B

In the case of the instruction templates of class B, the alpha field 852 is interpreted as a write mask control (Z) field 852C, whose content distinguishes whether the write masking controlled by the write mask field 870 should be a merging or a zeroing.

No-Memory Access Instruction Templates of Class B

In the case of the non-memory access 805 instruction templates of class B, part of the beta field 854 is interpreted as an RL field 857A, whose content distinguishes which one of the different augmentation operation types are to be performed (e.g., round 857A.1 and vector length (VSIZE) 857A.2 are respectively specified for the no memory access, write mask control, partial round control type operation 812 instruction template and the no memory access, write mask control, VSIZE type operation 817 instruction template), while the rest of the beta field 854 distinguishes which of the operations of the specified type is to be performed. In FIG. 8, rounded corner blocks are used to indicate a specific value is present (e.g., no memory access 846A in the modifier field 846; round 857A.1 and VSIZE 857A.2 for the RL field 857A). In the no memory access 805 instruction templates, the scale field 860, the displacement field 862A, and the displacement scale filed 862B are not present.

No-Memory Access Instruction Templates—Write Mask Control, Partial Round Control Type Operation

In the no memory access, write mask control, partial round control type operation 810 instruction template, the rest of the beta field 854 is interpreted as a round operation field 859A and exception event reporting is disabled (a given instruction does not report any kind of floating-point exception flag and does not raise any floating point exception handler).

Round operation control field 859A—just as round operation control field 858, its content distinguishes which one of a group of rounding operations to perform (e.g., Round-up, Round-down, Round-towards-zero and Round-to-nearest). Thus, the round operation control field 859A allows for the changing of the rounding mode on a per instruction basis, and thus is particularly useful when this is required. In one embodiment of the invention where a processor includes a control register for specifying rounding modes, the round operation control field's 850 content overrides that register value (Being able to choose the rounding mode without having to perform a save-modify-restore on such a control register is advantageous).

No Memory Access Instruction Templates—Write Mask Control, VSIZE Type Operation

In the no memory access, write mask control, VSIZE type operation 817 instruction template, the rest of the beta field 854 is interpreted as a vector length field 859B, whose content distinguishes which one of a number of data vector length is to be performed on (e.g., 128, 856, or 1012 byte).

Memory Access Instruction Templates of Class B

In the case of a memory access 820 instruction template of class A, part of the beta field 854 is interpreted as a broadcast field 857B, whose content distinguishes whether or not the broadcast type data manipulation operation is to be performed, while the rest of the beta field 854 is interpreted the vector length field 859B. The memory access 820 instruction templates include the scale field 860, and optionally the displacement field 862A or the displacement scale field 862B.

Additional Comments Regarding Fields

With regard to the generic vector friendly instruction format 800, a full opcode field 874 is shown including the format field 840, the base operation field 842, and the data element width field 864. While one embodiment is shown where the full opcode field 874 includes all of these fields, the full opcode field 874 includes less than all of these fields in embodiments that do not support all of them. The full opcode field 874 provides the operation code.

The augmentation operation field 850, the data element width field 864, and the write mask field 870 allow these features to be specified on a per instruction basis in the generic vector friendly instruction format.

The combination of write mask field and data element width field create typed instructions in that they allow the mask to be applied based on different data element widths.

The instruction format requires a relatively small number of bits because it reuses different fields for different purposes based on the contents of other fields. For instance, one perspective is that the modifier field's content choses between the no memory access 805 instructions templates on FIGS. 8A-B and the memory access 8250 instruction templates on FIGS. 8A-B; while the class field 868's content choses within those non-memory access 805 instruction templates between instruction templates 810/815 of FIG. 8A and 812/817 of FIG. 8B; and while the class field 868's content choses within those memory access 820 instruction templates between instruction templates 825/830 of FIGS. 8A and 827 of FIG. 8B. From another perspective, the class field 868's content choses between the class A and class B instruction templates respectively of FIGS. 8A and B; while the modifier field's content choses within those class A instruction templates between instruction templates 805 and 820 of FIG. 8A; and while the modifier field's content choses within those class B instruction templates between instruction templates 805 and 820 of FIG. 8B. In the case of the class field's content indicating a class A instruction template, the content of the modifier field 846 choses the interpretation of the alpha field 852 (between the rs field 852A and the EH field 852B. In a related manner, the contents of the modifier field 846 and the class field 868 chose whether the alpha field is interpreted as the rs field 852A, the EH field 852B, or the write mask control (Z) field 852C. In the case of the class and modifier fields indicating a class A no memory access operation, the interpretation of the augmentation field's beta field changes based on the rs field's content; while in the case of the class and modifier fields indicating a class B no memory access operation, the interpretation of the beta field depends on the contents of the RL field. In the case of the class and modifier fields indicating a class A memory access operation, the interpretation of the augmentation field's beta field changes based on the base operation field's content; while in the case of the class and modifier fields indicating a class B memory access operation, the interpretation of the augmentation field's beta field's broadcast field 857B changes based on the base operation field's contents. Thus, the combination of the base operation field, modifier field and the augmentation operation field allow for an even wider variety of augmentation operations to be specified.

The various instruction templates found within class A and class B are beneficial in different situations. Class A is useful when zeroing-writemasking or smaller vector lengths are desired for performance reasons. For example, zeroing allows avoiding fake dependences when renaming is used since we no longer need to artificially merge with the destination; as another example, vector length control eases store-load forwarding issues when emulating shorter vector sizes with the vector mask. Class B is useful when it is desirable to: 1) allow floating point exceptions (i.e., when the contents of the SAE field indicate no) while using rounding-mode controls at the same time; 2) be able to use upconversion, swizzling, swap, and/or downconversion; 3) operate on the graphics data type. For instance, upconversion, swizzling, swap, downconversion, and the graphics data type reduce the number of instructions required when working with sources in a different format; as another example, the ability to allow exceptions provides full IEEE compliance with directed rounding-modes.

Exemplary Specific Vector Friendly Instruction Format

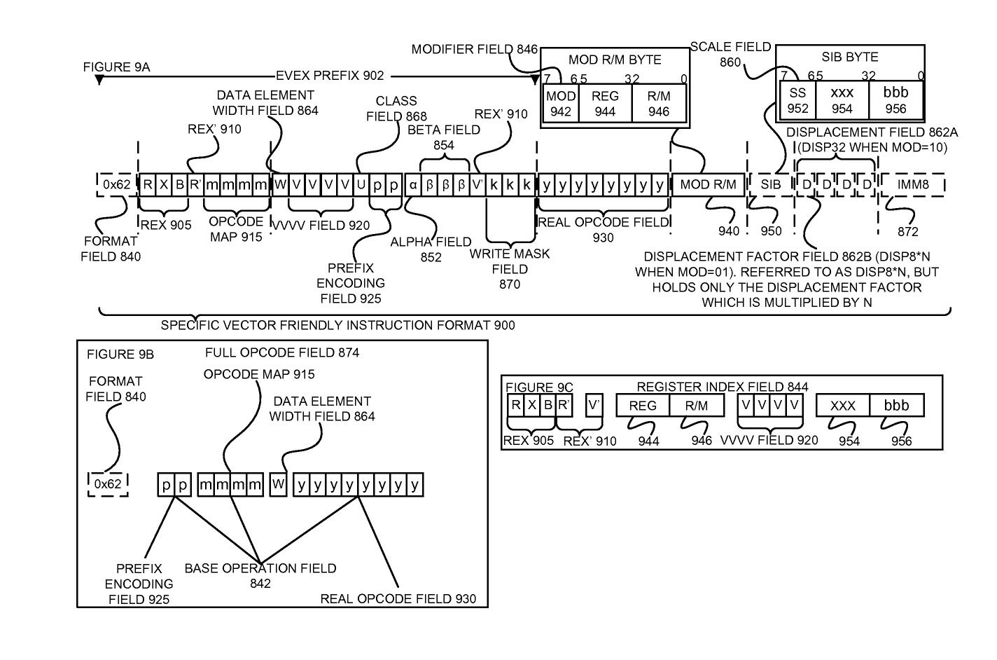

FIG. 9 is a block diagram illustrating an exemplary specific vector friendly instruction format according to embodiments of the invention. FIG. 9 shows a specific vector friendly instruction format 900 that is specific in the sense that it specifies the location, size, interpretation, and order of the fields, as well as values for some of those fields. The specific vector friendly instruction format 900 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 8 into which the fields from FIG. 9 map are illustrated.

It should be understand that although embodiments of the invention are described with reference to the specific vector friendly instruction format 900 in the context of the generic vector friendly instruction format 800 for illustrative purposes, the invention is not limited to the specific vector friendly instruction format 900 except where claimed. For example, the generic vector friendly instruction format 800 contemplates a variety of possible sizes for the various fields, while the specific vector friendly instruction format 900 is shown as having fields of specific sizes. By way of specific example, while the data element width field 864 is illustrated as a one bit field in the specific vector friendly instruction format 900, the invention is not so limited (that is, the generic vector friendly instruction format 800 contemplates other sizes of the data element width field 864).

Format—FIG. 9

The generic vector friendly instruction format 800 includes the following fields listed below in the order illustrated in FIG. 9.

EVEX Prefix (Bytes 0-3)

EVEX Prefix 902—is encoded in a four-byte form.

Format Field 840 (EVEX Byte 0, bits [7:0])—the first byte (EVEX Byte 0) is the format field 840 and it contains 0x62 (the unique value used for distinguishing the vector friendly instruction format in one embodiment of the invention).

The second-fourth bytes (EVEX Bytes 1-3) include a number of bit fields providing specific capability.

REX field 905 (EVEX Byte 1, bits [7-5])—consists of a EVEX.R bit field (EVEX Byte 1, bit [7]-R), EVEX.X bit field (EVEX byte 1, bit [6]-X), and 857BEX byte 1, bit[5]-B). The EVEX.R, EVEX.X, and EVEX.B bit fields provide the same functionality as the corresponding VEX bit fields, and are encoded using 1s complement form, i.e. ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 910—this is the first part of the REX′ field 910 and is the EVEX.R′ bit field (EVEX Byte 1, bit [4]-R′) that is used to encode either the upper 16 or lower 16 of the extended 32 register set. In one embodiment of the invention, this bit, along with others as indicated below, is stored in bit inverted format to distinguish (in the well-known x86 32-bit mode) from the BOUND instruction, whose real opcode byte is 62, but does not accept in the MOD RIM field (described below) the value of 11 in the MOD field; alternative embodiments of the invention do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 915 (EVEX byte 1, bits [3:0]-mmmm)—its content encodes an implied leading opcode byte (0F, 0F 38, or 0F 3).

Data element width field 864 (EVEX byte 2, bit [7]-W)—is represented by the notation EVEX.W. EVEX.W is used to define the granularity (size) of the datatype (either 32-bit data elements or 64-bit data elements).

EVEX.vvvv 920 (EVEX Byte 2, bits [6:3]-vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in 1s complement form for certain vector shifts; or 3) EVEX.vvvv does not encode any operand, the field is reserved and should contain 1111b. Thus, EVEX.vvvv field 920 encodes the 4 low-order bits of the first source register specifier stored in inverted (1s complement) form. Depending on the instruction, an extra different EVEX bit field is used to extend the specifier size to 32 registers.

EVEX.U 868 Class field (EVEX byte 2, bit [2]-U)—If EVEX.U=0, it indicates class A or EVEX.U0; if EVEX.U=1, it indicates class B or EVEX.U1.

Prefix encoding field 925 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 852 (EVEX byte 3, bit [7]-EH; also known as EVEX.EH, EVEX.rs, EVEX.RL, EVEX.write mask control, and EVEX.N; also illustrated with α)—as previously described, this field is context specific. Additional description is provided later herein.

Beta field 854 (EVEX byte 3, bits [6:4]-SSS, also known as EVEX.s₂₋₀, EVEX.r₂₋₀, EVEX.rr1, EVEX.LL0, EVEX.LLB; also illustrated with βββ)—as previously described, this field is context specific. Additional description is provided later herein.

REX′ field 910—this is the remainder of the REX′ field and is the EVEX.V′ bit field (EVEX Byte 3, bit [3]-V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 870 (EVEX byte 3, bits [2:0]-kkk)—its content specifies the index of a register in the write mask registers as previously described. In one embodiment of the invention, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 930 (Byte 4)

This is also known as the opcode byte. Part of the opcode is specified in this field.

MOD R/M Field 940 (Byte 5)

Modifier field 846 (MODR/M.MOD, bits [7-6]-MOD field 942)—As previously described, the MOD field's 942 content distinguishes between memory access and non-memory access operations. This field will be further described later herein.

MODR/M.reg field 944, bits [5-3]—the role of ModR/M.reg field can be summarized to two situations: ModR/M.reg encodes either the destination register operand or a source register operand, or ModR/M.reg is treated as an opcode extension and not used to encode any instruction operand.

MODR/M.r/m field 946, bits [2-0]—The role of ModR/M.r/m field may include the following: ModR/M.r/m encodes the instruction operand that references a memory address, or ModR/M.r/m encodes either the destination register operand or a source register operand.

Scale, Index, Base (SIB) Byte (Byte 6)

Scale field 860 (SIB.SS, bits [7-6]—As previously described, the scale field's 860 content is used for memory address generation. This field will be further described later herein.

SIB.xxx 954 (bits [5-3] and SIB.bbb 956 (bits [2-0])—the contents of these fields have been previously referred to with regard to the register indexes Xxxx and Bbbb.

Displacement Byte(s) (Byte 7 or Bytes 7-10)

Displacement field 862A (Bytes 7-10)—when MOD field 942 contains 10, bytes 7-10 are the displacement field 862A, and it works the same as the legacy 32-bit displacement (disp32) and works at byte granularity.

Displacement factor field 862B (Byte 7)—when MOD field 942 contains 01, byte 7 is the displacement factor field 862B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 862B is a reinterpretation of disp8; when using displacement factor field 862B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 862B substitutes the legacy x86 instruction set 8-bit displacement. Thus, the displacement factor field 862B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset).

Immediate

Immediate field 872 operates as previously described.

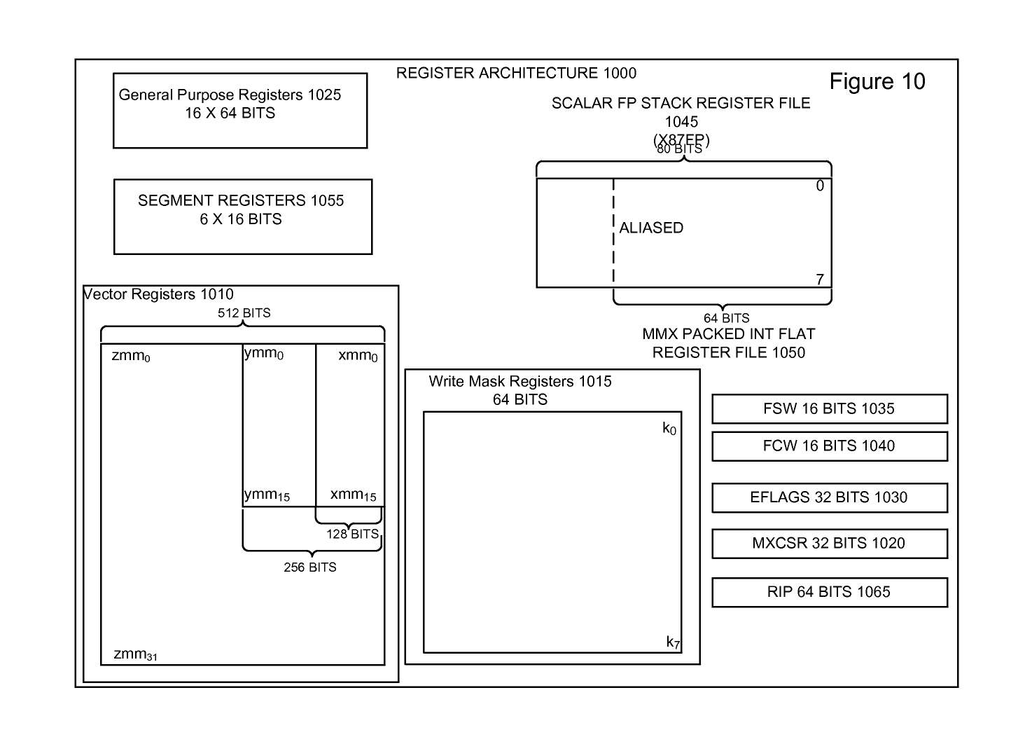

Exemplary Register Architecture—FIG. 10

FIG. 10 is a block diagram of a register architecture 1000 according to one embodiment of the invention. The register files and registers of the register architecture are listed below:

Vector register file 1010—in the embodiment illustrated, there are 32 vector registers that are 1012 bits wide; these registers are referenced as zmm0 through zmm31. The lower order 856 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 900 operates on these overlaid register file as illustrated in the below tables.

| Adjustable | | | |
|---|---|---|---|
| Vector Length | Class | Operations | Registers |
| Instruction | A (FIG. 8A; | 810, 815, 825, | zmm registers |
| Templates that | U = 0) | 830 | (the vector |
| do not include | | | length is 64 byte) |
| the vector length | B (FIG. 8B; | 812 | zmm registers |
| field 859B | U = 1) | | (the vector |
| | | | length is 64 byte) |
| Instruction | B (FIG. 8B; | 817, 827 | zmm, ymm, or |
| Templates that | U = 1) | | xmm registers |
| do include the | | | (the vector |
| vector length | | | length is 64 byte, |
| field 859B | | | 32 byte, or 16 |
| | | | byte) depending |
| | | | on the vector |
| | | | length field 859B |

In other words, the vector length field 859B selects between a maximum length and one or more other shorter lengths, where each such shorter length is half the length of the preceding length; and instructions templates without the vector length field 859B operate on the maximum vector length. Further, in one embodiment, the class B instruction templates of the specific vector friendly instruction format 900 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 1015—in the embodiment illustrated, there are 8 write mask registers (k0 through k7), each 64 bits in size. As previously described, in one embodiment of the invention the vector mask register k0 cannot be used as a write mask; when the encoding that would normally indicate k0 is used for a write mask, it selects a hardwired write mask of 0xFFFF, effectively disabling write masking for that instruction.

Multimedia Extensions Control Status Register (MXCSR) 1020—in the embodiment illustrated, this 32-bit register provides status and control bits used in floating-point operations.

General-purpose registers 1025—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Extended flags (EFLAGS) register 1030—in the embodiment illustrated, this 32 bit register is used to record the results of many instructions.

Floating Point Control Word (FCW) register 1035 and Floating Point Status Word (FSW) register 1040—in the embodiment illustrated, these registers are used by x87 instruction set extensions to set rounding modes, exception masks and flags in the case of the FCW, and to keep track of exceptions in the case of the FSW.

Scalar floating point stack register file (x87 stack) 1045 on which is aliased the MMX packed integer flat register file 1050—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Segment registers 1055—in the illustrated embodiment, there are six 16 bit registers use to store data used for segmented address generation.

RIP register 1065—in the illustrated embodiment, this 64 bit register that stores the instruction pointer.

Alternative embodiments of the invention may use wider or narrower registers. Additionally, alternative embodiments of the invention may use more, less, or different register files and registers.

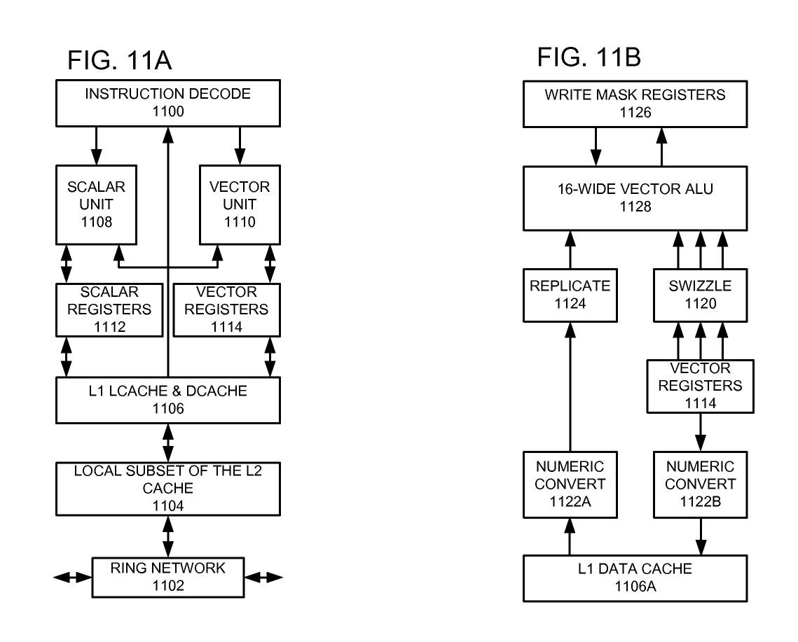

Exemplary In-Order Processor Architecture—FIGS. 11A-11B

FIGS. 11A-B illustrate a block diagram of an exemplary in-order processor architecture. These exemplary embodiments are designed around multiple instantiations of an in-order CPU core that is augmented with a wide vector processor (VPU). Cores communicate through a high-bandwidth interconnect network with some fixed function logic, memory I/O interfaces, and other necessary I/O logic, depending on the e13t application. For example, an implementation of this embodiment as a stand-alone GPU would typically include a PCIe bus.

FIG. 11A is a block diagram of a single CPU core, along with its connection to the on-die interconnect network 1102 and with its local subset of the level 2 (L2) cache 1104, according to embodiments of the invention. An instruction decoder 1100 supports the x86 instruction set with an extension including the specific vector instruction format 900. While in one embodiment of the invention (to simplify the design) a scalar unit 1108 and a vector unit 1110 use separate register sets (respectively, scalar registers 1112 and vector registers 1114) and data transferred between them is written to memory and then read back in from a level 1 (L1) cache 1106, alternative embodiments of the invention may use a different approach (e.g., use a single register set or include a communication path that allow data to be transferred between the two register files without being written and read back).

The L1 cache 1106 allows low-latency accesses to cache memory into the scalar and vector units. Together with load-op instructions in the vector friendly instruction format, this means that the L1 cache 1106 can be treated somewhat like an extended register file. This significantly improves the performance of many algorithms, especially with the eviction hint field 852B.

The local subset of the L2 cache 1104 is part of a global L2 cache that is divided into separate local subsets, one per CPU core. Each CPU has a direct access path to its own local subset of the L2 cache 1104. Data read by a CPU core is stored in its L2 cache subset 1104 and can be accessed quickly, in parallel with other CPUs accessing their own local L2 cache subsets. Data written by a CPU core is stored in its own L2 cache subset 1104 and is flushed from other subsets, if necessary. The ring network ensures coherency for shared data.

FIG. 11B is an exploded view of part of the CPU core in FIG. 11A according to embodiments of the invention. FIG. 11B includes an L1 data cache 1106A part of the L1 cache 1104, as well as more detail regarding the vector unit 1110 and the vector registers 1114. Specifically, the vector unit 1110 is a 16-wide vector processing unit (VPU) (see the 16-wide ALU 1128), which executes integer, single-precision float, and double-precision float instructions. The VPU supports swizzling the register inputs with swizzle unit 1120, numeric conversion with numeric convert units 1122A-B, and replication with replication unit 1124 on the memory input. Write mask registers 1126 allow predicating the resulting vector writes.

Register data can be swizzled in a variety of ways, e.g. to support matrix multiplication. Data from memory can be replicated across the VPU lanes. This is a common operation in both graphics and non-graphics parallel data processing, which significantly increases the cache efficiency.

The ring network is bi-directional to allow agents such as CPU cores, L2 caches and other logic blocks to communicate with each other within the chip. Each ring data-path is 1012-bits wide per direction.

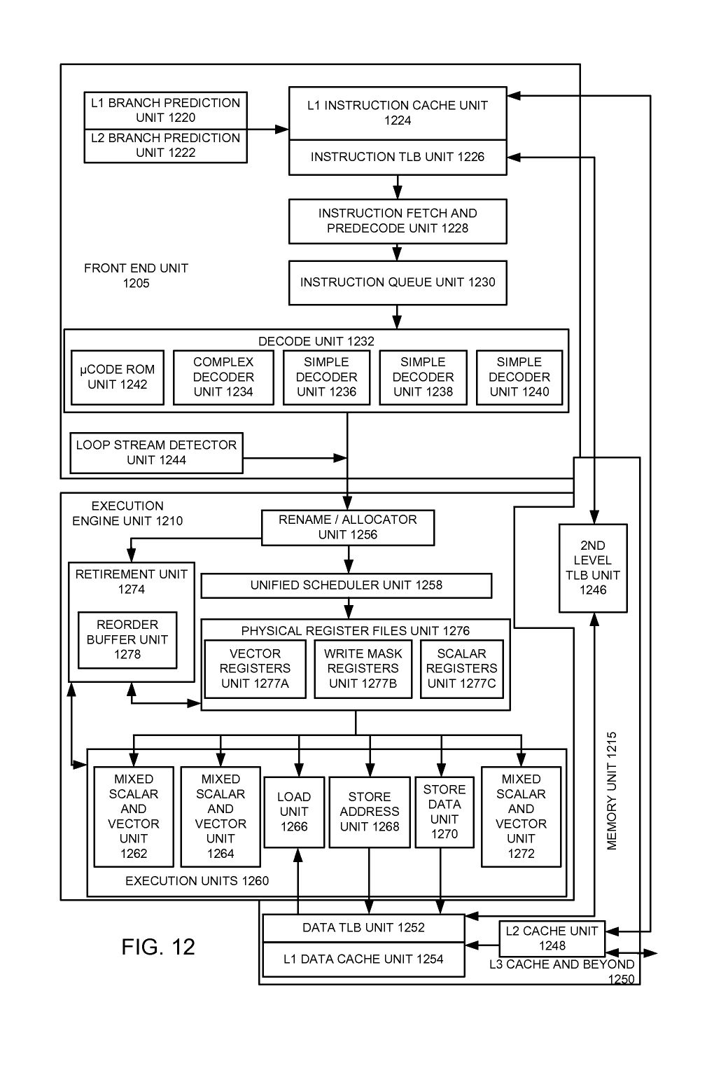

Exemplary Out-of-Order Architecture—FIG. 12

FIG. 12 is a block diagram illustrating an exemplary out-of-order architecture according to embodiments of the invention. Specifically, FIG. 12 illustrates a well-known exemplary out-of-order architecture that has been modified to incorporate the vector friendly instruction format and execution thereof. In FIG. 12 arrows denotes a coupling between two or more units and the direction of the arrow indicates a direction of data flow between those units. FIG. 12 includes a front end unit 1205 coupled to an execution engine unit 1210 and a memory unit 1215; the execution engine unit 1210 is further coupled to the memory unit 1215.

The front end unit 1205 includes a level 1 (L1) branch prediction unit 1220 coupled to a level 2 (L2) branch prediction unit 1222. The L1 and L2 brand prediction units 1220 and 1222 are coupled to an L1 instruction cache unit 1224. The L1 instruction cache unit 1224 is coupled to an instruction translation lookaside buffer (TLB) 1226 which is further coupled to an instruction fetch and predecode unit 1228. The instruction fetch and predecode unit 1228 is coupled to an instruction queue unit 1230 which is further coupled a decode unit 1232. The decode unit 1232 comprises a complex decoder unit 1234 and three simple decoder units 1236, 1238, and 1240. The decode unit 1232 includes a micro-code ROM unit 1242. The decode unit 1232 may operate as previously described above in the decode stage section. The L1 instruction cache unit 1224 is further coupled to an L2 cache unit 1248 in the memory unit 1215. The instruction TLB unit 1226 is further coupled to a second level TLB unit 1246 in the memory unit 1215. The decode unit 1232, the micro-code ROM unit 1242, and a loop stream detector unit 1244 are each coupled to a rename/allocator unit 1256 in the execution engine unit 1210.

The execution engine unit 1210 includes the rename/allocator unit 1256 that is coupled to a retirement unit 1274 and a unified scheduler unit 1258. The retirement unit 1274 is further coupled to execution units 1260 and includes a reorder buffer unit 1278. The unified scheduler unit 1258 is further coupled to a physical register files unit 1276 which is coupled to the execution units 1260. The physical register files unit 1276 comprises a vector registers unit 1277A, a write mask registers unit 1277B, and a scalar registers unit 1277C; these register units may provide the vector registers 1010, the vector mask registers 1015, and the general purpose registers 1025; and the physical register files unit 1276 may include additional register files not shown (e.g., the scalar floating point stack register file 1045 aliased on the MMX packed integer flat register file 1050). The execution units 1260 include three mixed scalar and vector units 1262, 1264, and 1272; a load unit 1266; a store address unit 1268; a store data unit 1270. The load unit 1266, the store address unit 1268, and the store data unit 1270 are each coupled further to a data TLB unit 1252 in the memory unit 1215.

The memory unit 1215 includes the second level TLB unit 1246 which is coupled to the data TLB unit 1252. The data TLB unit 1252 is coupled to an L1 data cache unit 1254. The L1 data cache unit 1254 is further coupled to an L2 cache unit 1248. In some embodiments, the L2 cache unit 1248 is further coupled to L3 and higher cache units 1250 inside and/or outside of the memory unit 1215.

By way of example, the exemplary out-of-order architecture may implement the process pipeline 8200 as follows: 1) the instruction fetch and predecode unit 1228 perform the fetch and length decoding stages; 2) the decode unit 1232 performs the decode stage; 3) the rename/allocator unit 1256 performs the allocation stage and renaming stage; 4) the unified scheduler 1258 performs the schedule stage; 5) the physical register files unit 1276, the reorder buffer unit 1278, and the memory unit 1215 perform the register read/memory read stage; the execution units 1260 perform the execute/data transform stage; 6) the memory unit 1215 and the reorder buffer unit 1278 perform the write back/memory write stage 1960; 7) the retirement unit 1274 performs the ROB read stage; 8) various units may be involved in the exception handling stage; and 9) the retirement unit 1274 and the physical register files unit 1276 perform the commit stage.

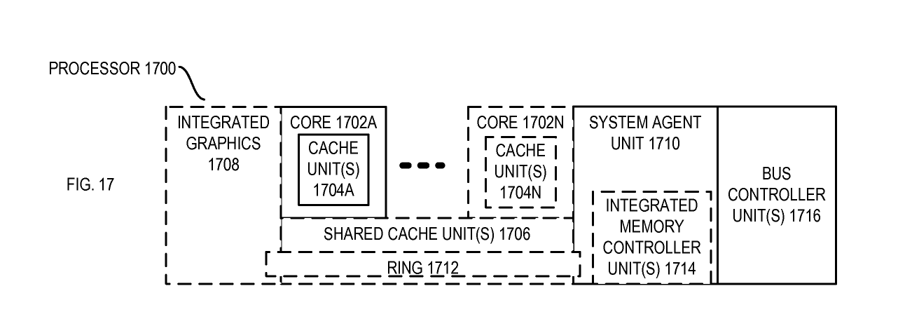

Exemplary Single Core and Multicore Processors—FIG. 17

FIG. 17 is a block diagram of a single core processor and a multicore processor 1700 with integrated memory controller and graphics according to embodiments of the invention. The solid lined boxes in FIG. 17 illustrate a processor 1700 with a single core 1702A, a system agent 1710, a set of one or more bus controller units 1716, while the optional addition of the dashed lined boxes illustrates an alternative processor 1700 with multiple cores 1702A-N, a set of one or more integrated memory controller unit(s) 1714 in the system agent unit 1710, and an integrated graphics logic 1708.

The memory hierarchy includes one or more levels of cache within the cores, a set or one or more shared cache units 1706, and external memory (not shown) coupled to the set of integrated memory controller units 1714. The set of shared cache units 1706 may include one or more mid-level caches, such as level 2 (L2), level 3 (L3), level 4 (L4), or other levels of cache, a last level cache (LLC), and/or combinations thereof. While in one embodiment a ring based interconnect unit 1712 interconnects the integrated graphics logic 1708, the set of shared cache units 1706, and the system agent unit 1710, alternative embodiments may use any number of well-known techniques for interconnecting such units.

In some embodiments, one or more of the cores 1702A-N are capable of multi-threading. The system agent 1710 includes those components coordinating and operating cores 1702A-N. The system agent unit 1710 may include for example a power control unit (PCU) and a display unit. The PCU may be or include logic and components needed for regulating the power state of the cores 1702A-N and the integrated graphics logic 1708. The display unit is for driving one or more externally connected displays.

The cores 1702A-N may be homogenous or heterogeneous in terms of architecture and/or instruction set. For example, some of the cores 1702A-N may be in order (e.g., like that shown in FIGS. 11A and 11B) while others are out-of-order (e.g., like that shown in FIG. 12). As another example, two or more of the cores 1702A-N may be capable of executing the same instruction set, while others may be capable of executing only a subset of that instruction set or a different instruction set. At least one of the cores is capable of executing the vector friendly instruction format described herein.

The processor may be a general-purpose processor, such as a Core™ i3, i5, i7, 2 Duo and Quad, Xeon™, or Itanium™ processor, which are available from Intel Corporation, of Santa Clara, Calif. Alternatively, the processor may be from another company. The processor may be a special-purpose processor, such as, for example, a network or communication processor, compression engine, graphics processor, co-processor, embedded processor, or the like. The processor may be implemented on one or more chips. The processor 1700 may be a part of and/or may be implemented on one or more substrates using any of a number of process technologies, such as, for example, BiCMOS, CMOS, or NMOS.

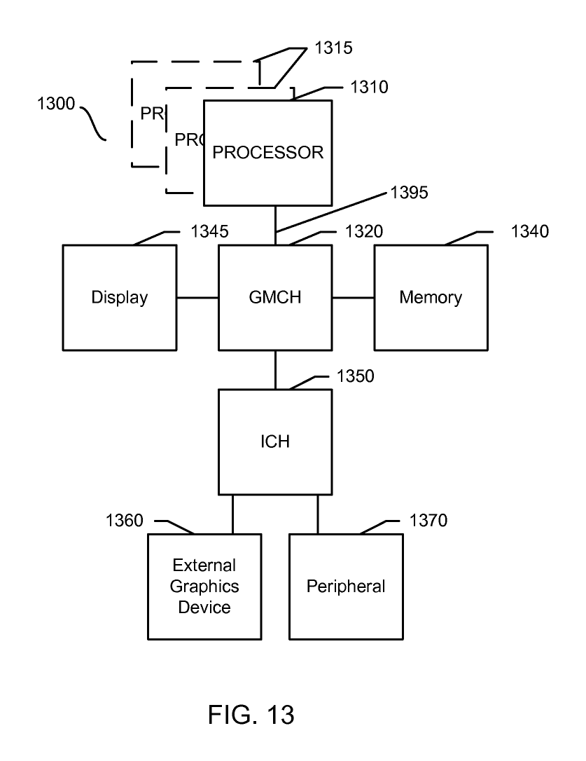

Exemplary Computer Systems and Processors—FIGS. 13-15

FIGS. 13-15 are exemplary systems suitable for including the processor 1700, while FIG. 88 is an exemplary system on a chip (SoC) that may include one or more of the cores 1702. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 13, shown is a block diagram of a system 1300 in accordance with one embodiment of the invention. The system 1300 may include one or more processors 1310, 1315, which are coupled to graphics memory controller hub (GMCH) 1320. The optional nature of additional processors 1315 is denoted in FIG. 13 with broken lines.

Each processor 1310, 1315 may be some version of processor 1700. However, it should be noted that it is unlikely that integrated graphics logic and integrated memory control units would exist in the processors 1310, 1315.

FIG. 13 illustrates that the GMCH 1320 may be coupled to a memory 1340 that may be, for example, a dynamic random access memory (DRAM). The DRAM may, for at least one embodiment, be associated with a non-volatile cache.

The GMCH 1320 may be a chipset, or a portion of a chipset. The GMCH 1320 may communicate with the processor(s) 1310, 1315 and control interaction between the processor(s) 1310, 1315 and memory 1340. The GMCH 1320 may also act as an accelerated bus interface between the processor(s) 1310, 1315 and other elements of the system 1300. For at least one embodiment, the GMCH 1320 communicates with the processor(s) 1310, 1315 via a multi-drop bus, such as a frontside bus (FSB) 1395.

Furthermore, GMCH 1320 is coupled to a display 1345 (such as a flat panel display). GMCH 1320 may include an integrated graphics accelerator. GMCH 1320 is further coupled to an input/output (I/O) controller hub (ICH) 1350, which may be used to couple various peripheral devices to system 1300. Shown for example in the embodiment of FIG. 13 is an external graphics device 1360, which may be a discrete graphics device coupled to ICH 1350, along with another peripheral device 1370.

Alternatively, additional or different processors may also be present in the system 1300. For example, additional processor(s) 1315 may include additional processors(s) that are the same as processor 1310, additional processor(s) that are heterogeneous or asymmetric to processor 1310, accelerators (such as, e.g., graphics accelerators or digital signal processing (DSP) units), field programmable gate arrays, or any other processor. There can be a variety of differences between the physical resources 1310, 1315 in terms of a spectrum of metrics of merit including architectural, microarchitectural, thermal, power consumption characteristics, and the like. These differences may effectively manifest themselves as asymmetry and heterogeneity amongst the processing elements 1310, 1315. For at least one embodiment, the various processing elements 1310, 1315 may reside in the same die package.

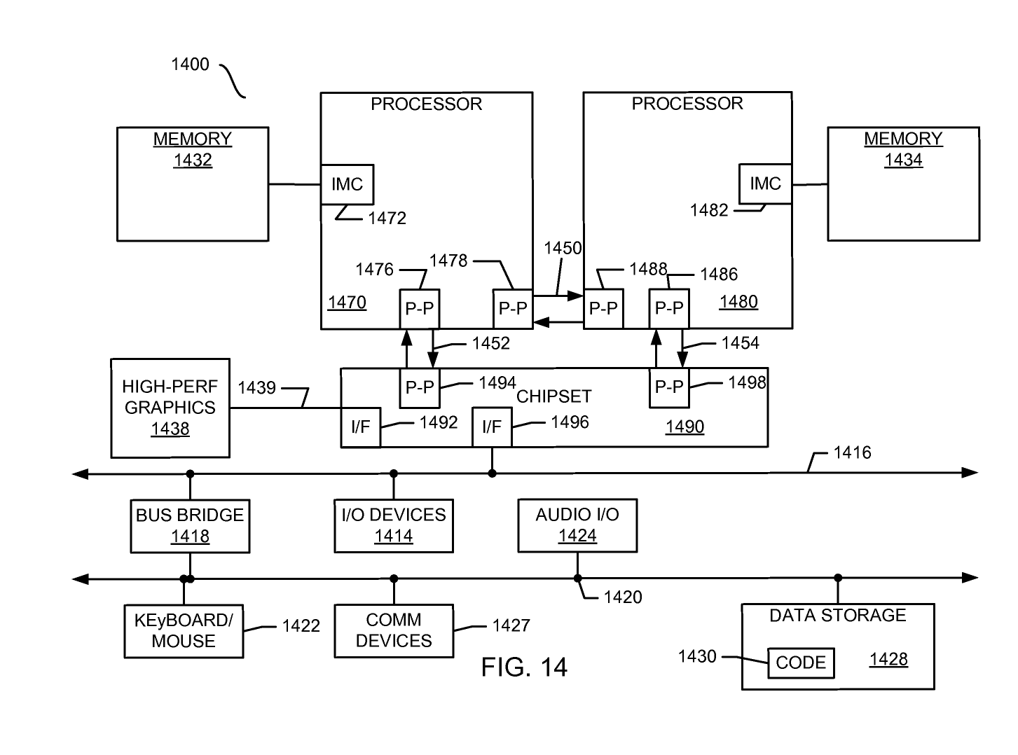

Referring now to FIG. 14, shown is a block diagram of a second system 1400 in accordance with an embodiment of the present invention. As shown in FIG. 14, multiprocessor system 1400 is a point-to-point interconnect system, and includes a first processor 1470 and a second processor 1480 coupled via a point-to-point interconnect 1450. As shown in FIG. 14, each of processors 1470 and 1480 may be some version of the processor 1700.

Alternatively, one or more of processors 1470, 1480 may be an element other than a processor, such as an accelerator or a field programmable gate array.

While shown with only two processors 1470, 1480, it is to be understood that the scope of the present invention is not so limited. In other embodiments, one or more additional processing elements may be present in a given processor.

Processor 1470 may further include an integrated memory controller hub (IMC) 1472 and point-to-point (P-P) interfaces 1476 and 1478. Similarly, second processor 1480 may include a IMC 1482 and P-P interfaces 1486 and 1488. Processors 1470, 1480 may exchange data via a point-to-point (PtP) interface 1450 using PtP interface circuits 1478, 1488. As shown in FIG. 14, IMC's 1472 and 1482 couple the processors to respective memories, namely a memory 1442 and a memory 1444, which may be portions of main memory locally attached to the respective processors.

Processors 1470, 1480 may each exchange data with a chipset 1490 via individual P-P interfaces 1452, 1454 using point to point interface circuits 1476, 1494, 1486, 1498. Chipset 1490 may also exchange data with a high-performance graphics circuit 1438 via a high-performance graphics interface 1439.

A shared cache (not shown) may be included in either processor outside of both processors, yet connected with the processors via P-P interconnect, such that either or both processors' local cache information may be stored in the shared cache if a processor is placed into a low power mode.

Chipset 1490 may be coupled to a first bus 1416 via an interface 1496. In one embodiment, first bus 1416 may be a Peripheral Component Interconnect (PCI) bus, or a bus such as a PCI Express bus or another third generation I/O interconnect bus, although the scope of the present invention is not so limited.

As shown in FIG. 14, various I/O devices 1414 may be coupled to first bus 1416, along with a bus bridge 1418 which couples first bus 1416 to a second bus 1420. In one embodiment, second bus 1420 may be a low pin count (LPC) bus. Various devices may be coupled to second bus 1420 including, for example, a keyboard/mouse 1422, communication devices 1426 and a data storage unit 1428 such as a disk drive or other mass storage device which may include code 1430, in one embodiment. Further, an audio I/O 1424 may be coupled to second bus 1420. Note that other architectures are possible. For example, instead of the point-to-point architecture of FIG. 14, a system may implement a multi-drop bus or other such architecture.

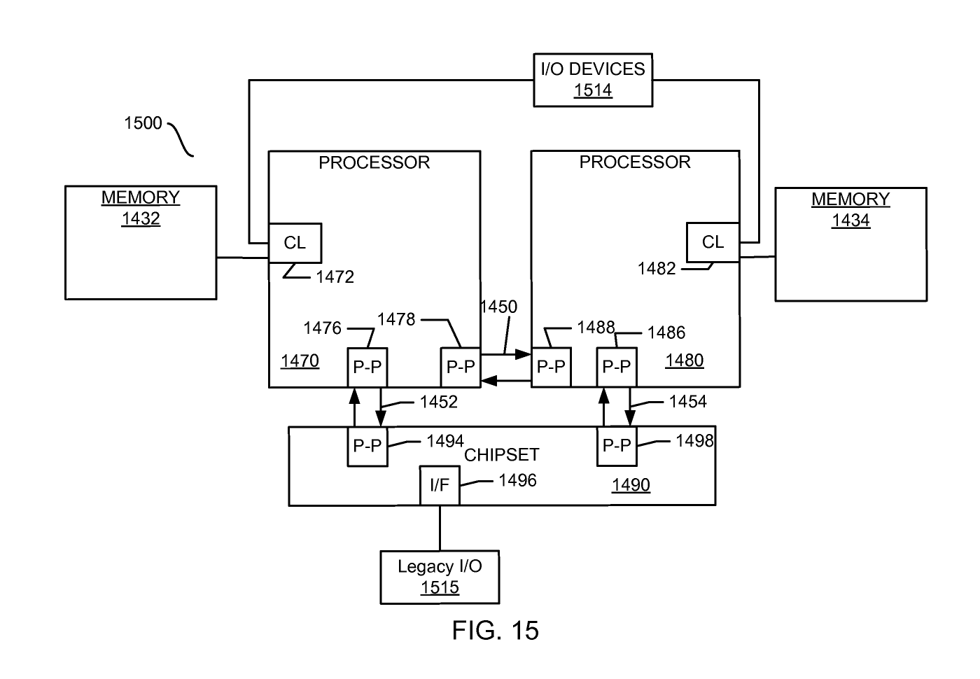

Referring now to FIG. 15, shown is a block diagram of a third system 1500 in accordance with an embodiment of the present invention. Like elements in FIGS. 14 and 15 bear like reference numerals, and certain aspects of FIG. 14 have been omitted from FIG. 15 in order to avoid obscuring other aspects of FIG. 15.

FIG. 15 illustrates that the processing elements 1470, 1480 may include integrated memory and I/O control logic (“CL”) 1472 and 1482, respectively. For at least one embodiment, the CL 1472, 1482 may include memory controller hub logic (IMC) such as that described above in connection with FIGS. 89 and 14. In addition. CL 1472, 1482 may also include I/O control logic. FIG. 15 illustrates that not only are the memories 1442, 1444 coupled to the CL 1472, 1482, but also that I/O devices 1514 are also coupled to the control logic 1472, 1482. Legacy I/O devices 1515 are coupled to the chipset 1490.

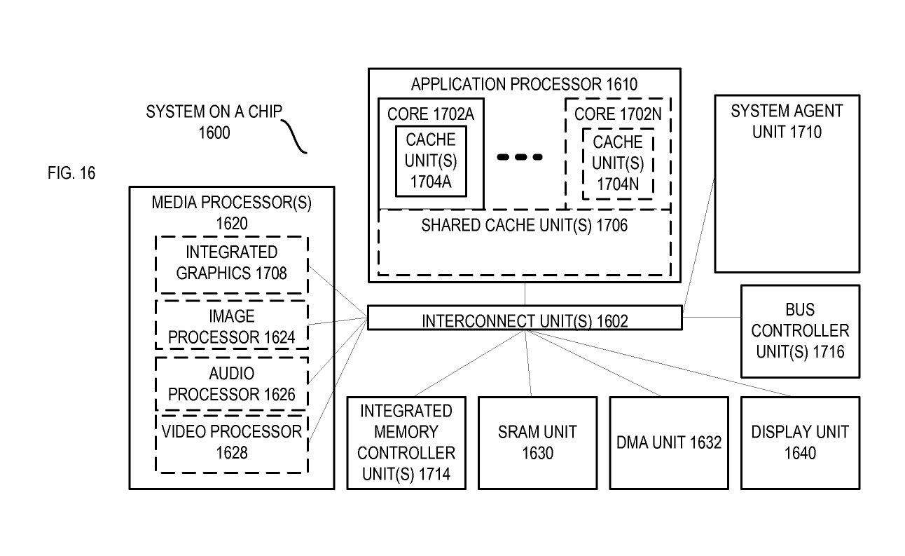

Referring now to FIG. 16, shown is a block diagram of a SoC 1600 in accordance with an embodiment of the present invention. Similar elements in FIG. 17 bear like reference numerals. Also, dashed lined boxes are optional features on more advanced SoCs. In FIG. 16, an interconnect unit(s) 1602 is coupled to: an application processor 1610 which includes a set of one or more cores 1702A-N and shared cache unit(s) 1706; a system agent unit 1710; a bus controller unit(s) 1716; an integrated memory controller unit(s) 1714; a set or one or more media processors 1620 which may include integrated graphics logic 1708, an image processor 1624 for providing still and/or video camera functionality, an audio processor 1626 for providing hardware audio acceleration, and a video processor 1628 for providing video encode/decode acceleration; an static random access memory (SRAM) unit 1630; a direct memory access (DMA) unit 1632; and a display unit 1640 for coupling to one or more external displays.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code may be applied to input data to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks (compact disk read-only memories (CD-ROMs), compact disk rewritables (CD-RWs)), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, embodiments of the invention also include non-transitory, tangible machine-readable media containing instructions the vector friendly instruction format or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

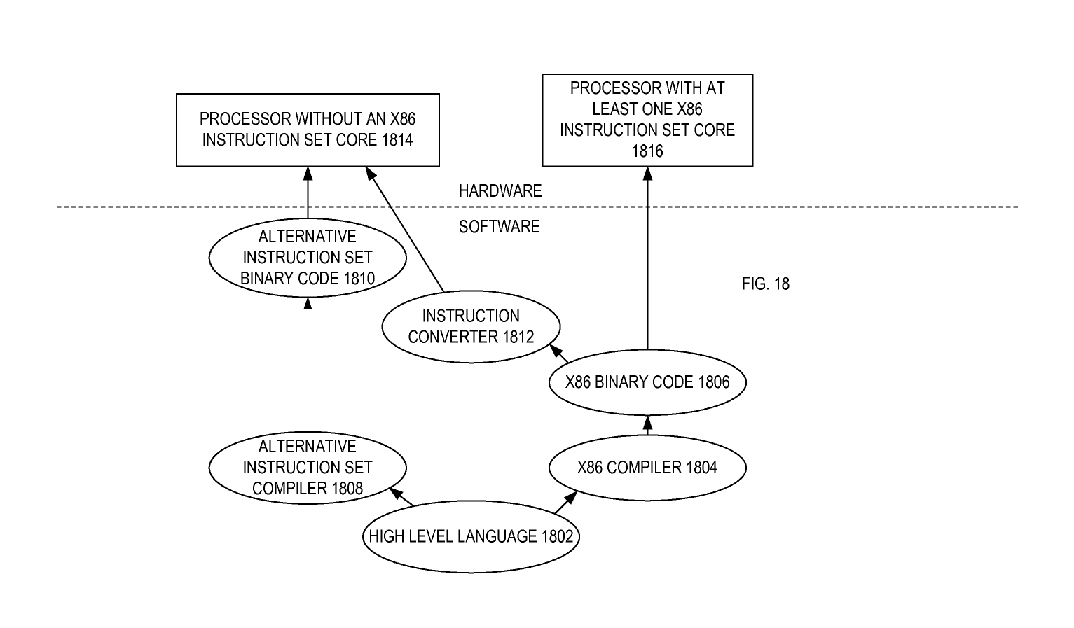

FIG. 18 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 18 shows a program in a high level language 1802 may be compiled using an x86 compiler 1804 to generate x86 binary code 1806 that may be natively executed by a processor with at least one x86 instruction set core 1816 (it is assume that some of the instructions that were compiled are in the vector friendly instruction format). The processor with at least one x86 instruction set core 1816 represents any processor that can perform substantially the same functions as a Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1804 represents a compiler that is operable to generate x86 binary code 1806 (e.g., object code) that can, with or without additional linkage processing, be executed on the processor with at least one x86 instruction set core 1816. Similarly, FIG. 90 shows the program in the high level language 1802 may be compiled using an alternative instruction set compiler 1808 to generate alternative instruction set binary code 1810 that may be natively executed by a processor without at least one x86 instruction set core 1814 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1812 is used to convert the x86 binary code 1806 into code that may be natively executed by the processor without an x86 instruction set core 1814. This converted code is not likely to be the same as the alternative instruction set binary code 1810 because an instruction converter capable of this is difficult to make; however, the converted code will accomplish the general operation and be made up of instructions from the alternative instruction set. Thus, the instruction converter 1812 represents software, firmware, hardware, or a combination thereof that, through emulation, simulation or any other process, allows a processor or other electronic device that does not have an x86 instruction set processor or core to execute the x86 binary code 1806.

Certain operations of the instruction(s) in the vector friendly instruction format disclosed herein may be performed by hardware components and may be embodied in machine-executable instructions that are used to cause, or at least result in, a circuit or other hardware component programmed with the instructions performing the operations. The circuit may include a general-purpose or special-purpose processor, or logic circuit, to name just a few examples. The operations may also optionally be performed by a combination of hardware and software. Execution logic and/or a processor may include specific or particular circuitry or other logic responsive to a machine instruction or one or more control signals derived from the machine instruction to store an instruction specified result operand. For example, embodiments of the instruction(s) disclosed herein may be executed in one or more the systems of FIGS. 13-16 and embodiments of the instruction(s) in the vector friendly instruction format may be stored in program code to be executed in the systems. Additionally, the processing elements of these figures may utilize one of the detailed pipelines and/or architectures (e.g., the in-order and out-of-order architectures) detailed herein. For example, the decode unit of the in-order architecture may decode the instruction(s), pass the decoded instruction to a vector or scalar unit, etc.

The above description is intended to illustrate preferred embodiments of the present invention. From the discussion above it should also be apparent that especially in such an area of technology, where growth is fast and further advancements are not easily foreseen, the invention can may be modified in arrangement and detail by those skilled in the art without departing from the principles of the present invention within the scope of the accompanying claims and their equivalents. For example, one or more operations of a method may be combined or further broken apart.

### Alternative Embodiments

While embodiments have been described which would natively execute the vector friendly instruction format, alternative embodiments of the invention may execute the vector friendly instruction format through an emulation layer running on a processor that executes a different instruction set (e.g., a processor that executes the MIPS instruction set of MIPS Technologies of Sunnyvale, Calif., a processor that executes the ARM instruction set of ARM Holdings of Sunnyvale, Calif.). Also, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate embodiments of the invention. The scope of the invention is not to be determined by the specific examples provided above but only by the claims below.

1. A method of performing an align instruction in a computer processor, comprising:
fetching the align instruction, wherein the align instruction includes a writemask operand, a destination operand, a first source operand, a second source operand, and an offset value;
decoding the fetched align instruction;
executing the decoded align instruction by
concatenating a first plurality of data elements of the first source operand and a second plurality of data elements of the second source operand,
shifting right the concatenated data elements based on the offset value, and
determining which of the right shifted, concatenated data elements are to be stored into corresponding position of the destination based on corresponding bits of the writemask; and
storing those data elements of the right shifted, concatenated data elements that have been determined should be stored into the destination at the corresponding position in the destination.

2. The method of claim 1, wherein the writemask is a 16-bit register.

3. The method of claim 1, wherein the offset is an 8-bit immediate value.

4. The method of claim 1, further comprising:
determining if the writemask is to be used; and
if the writemask is not to be used, storing the data elements of the right shifted, concatenated data elements at the corresponding locations of the destination without determining which of the right shifted, concatenated data elements are to be stored into corresponding position of the destination based on corresponding bits of the writemask.

5. The method of claim 1, wherein the determining is done for each bit position of the writemask in parallel.

6. The method of claim 1, wherein the first and second source operands are 512-bit registers.

7. The method of claim 1, wherein the second source operand is a 512-bit memory location and the data elements from that memory location are loaded into a temporary 512-bit register prior to the concatenation of the sources.

8. The method of claim 1, wherein the data elements of the first operand are the least significant data elements of the right shifted, concatenated data elements.

9. A method, comprising:
in response to an align instruction that includes a first and second source operand, a destination operand, a writemask operand, and an offset,
concatenating a first set of data elements of the first source with a second set of data elements of the second source;
right shifting the concatenated data elements by X data elements, wherein X is an immediate value provided in the align instruction; and
for a first bit position of a writemask, determining if that the first bit position indicates that the corresponding data element of the shifted, concatenated data elements is to be stored in a corresponding location in the destination,
storing the corresponding data element of the shifted, concatenated data elements is to be stored in a corresponding location in the destination when the first bit position of the writemask indicates that it should be stored, and
leaving a data element in the corresponding location in the destination alone when the first bit position of the writemask indicates that its corresponding data element should not be stored in the destination.

10. The method of claim 9, further comprising:
concatenating a first set of data elements of the first source with a second set of data elements of the second source;
for a second bit position of a writemask, determining if that the second bit position indicates that the corresponding data element of the shifted, concatenated data elements is to be stored in a corresponding location in the destination,
storing the corresponding data element of the shifted, concatenated data elements is to be stored in a corresponding location in the destination when the second bit position of the writemask indicates that it should be stored, and
leaving a data element in the corresponding location in the destination alone when the second bit position of the writemask indicates that its corresponding data element should not be stored in the destination.

11. The method of claim 10, further comprising:
determining when the last bit position has been evaluated to determine if its corresponding data element of the shifted, concatenated data elements is to be stored in a corresponding location in the destination to complete the align instruction.

12. The method of claim 9, wherein the first bit position of the writemask is the least significant bit of the writemask.

13. The method of claim 9, wherein the writemask is a 16-bit register.

14. The method of claim 9, wherein the offset is an 8-bit immediate value.

15. The method of claim 9, wherein the determining is done for each bit position of the writemask in parallel.

16. The method of claim 1, wherein the first and second source operands are 512-bit registers.

17. The method of claim 1, wherein the second source operand is a 512-bit memory location and the data elements from that memory location are loaded into a temporary 512-bit register prior to the concatenation of the sources.

18. An apparatus comprising;
a hardware decoder to decode an align instruction, wherein the align instruction includes a writemask operand, a destination operand, a first source operand, a second source operand, and an offset value;
execution logic to
concatenate a first plurality of data elements of the first source operand and a second plurality of data elements of the second source operand,
shift right the concatenated data elements based on the offset value,
determining which of the right shifted, concatenated data elements are to be stored into corresponding position of the destination based on corresponding bits of the writemask, and
store those data elements of the right shifted, concatenated data elements that have been determined should be stored into the destination at the corresponding position in the destination.

19. The apparatus of claim 18, further comprising:
a 16-bit writemask register to store the writemask; and
at least two 512-bit registers to store the data elements of the first and second sources.
